(19) United States
(12) Patent Application Publication
(10) Pub. No.: US 2025/0332040 A1
(43) Pub. Date: Oct. 30, 2025

(54) PASSENGER SEAT SUBASSEMBLIES FOR REDUCED MOBILITY ACCESS

(71) Applicant: B/E Aerospace, Inc., Winston-Salem, NC (US)

(72) Inventors: Jaganmohan Reddy Kovvuri, East Godavari (IN); Arjun Koustubhan, Hyderabad (IN); Sambasiva Rao Kodati, Vinjaram (IN); Chandra Sekhar Gudla, Hyderabad (IN)

(21) Appl. No.: 19/185,694

(22) Filed: Apr. 22, 2025

(30) Foreign Application Priority Data
Apr. 25, 2024 (IN) 202441032916

(51) Int. Cl. A61G 3/02; B64D 11/06

(52) U.S. Cl. CPC A61G 3/02; B64D 11/0644; A61G 2220/10

(57) ABSTRACT

Subassemblies mountable to passenger seats and passenger seats reconfigurable for reduced mobility access in aircraft and other environments. In embodiments, the assemblies include seat pan and armrest subassemblies with movable frame members for transitioning the seat between a sitting position and a temporary transfer position. In some embodiments, the motions are decoupled whereas in other embodiments the motions are coordinated and sequential. In a particular application, portions of the seat pan and armrest subassemblies are repositionable toward an aisle to facilitate wheelchair transfer.

### CROSS REFERENCE TO RELATED APPLICATION

This application claims the benefit of Indian Provisional Patent Application Number 202441032916 filed Apr. 25, 2024 for PASSENGER SEAT SUBASSEMBLIES FOR REDUCED MOBILITY ACCESS, which is hereby incorporated by reference in its entirety.

### TECHNICAL FIELD AND BACKGROUND

The present disclosure relates generally to improving seat access for reduced mobility passengers, and more particularly, to repositionable seat pan and armrest subassemblies for achieving a temporary transfer position to facilitate reduced mobility seat access.

Aircraft and other passenger conveyances includes various types and configurations of passenger seats. For example, seats in economy classes may be configured as forward facing seat rows to maximize seating density, seats in premium classes may be configured as forward facing or angled standalone seats to enhance comfort and privacy, and seats in super first class cabins may be configured as highly adjustable seats positioned in individual suites to maximize privacy.

Most traveling passengers are able to access and use their seat without extra assistance and accommodations. As such, most seats in an aircraft are standard access seats. Some passengers, however, may require extra assistance, referred to herein as reduced mobility passengers or commonly PRM (passenger with reduced mobility). For example, PRM passengers may require a transfer wheelchair for traveling the aisle and help from the flight crew at their seat location to make the transfer from the wheelchair to the seat and back again. Since the number of PRM passengers on any given flight is typically small, cabins are usually equipped with a very limited number of handicap accessible seats.

Traditional handicap accessibility in an aircraft is not associated with the seat itself, but instead pertains to spatial expansion around the seat to accommodate a wheelchair and the flight crew needed to perform a transfer. Spatial accommodations not only decrease the seating density of the aircraft, but position PRM passengers in dedicated parts of the cabin, and in some cases segregate PRM passengers from other passengers and travel companions.

Therefore, what is needed is a solution for improving seat access in a standard seating configuration.

### BRIEF SUMMARY

According to one aspect, the inventive concepts according to the present disclosure are directed to an assembly configured to be mounted to a passenger seat, wherein the assembly is configured to transition between a sitting position and a temporary transfer position. The assembly includes a seat pan subassembly including a stationary seat pan frame, and a movable seat pan frame mounted to the stationary seat pan frame, the movable seat pan frame movable between a first position corresponding to the sitting position and a second position corresponding to the temporary transfer position. The assembly further includes an armrest subassembly including a stationary armrest frame, and a movable armrest frame mounted to the stationary armrest frame, the movable armrest frame movable between a first position corresponding to the sitting position and a second position corresponding to the temporary transfer position.

In some embodiments, the assembly further includes an actuator coupled between the stationary seat pan frame and the movable seat pan frame configured to move the movable seat pan frame between the first position and the second position, and a locking gas spring coupled between the stationary armrest frame and the movable armrest frame, the locking gas spring configured to store energy when the movable armrest frame is moved toward the second position and provide lift assistance to move the movable armrest frame toward the first position.

In some embodiments, the movable seat pan frame is translatably mounted to the stationary seat pan frame, and the movable armrest frame is translatably mounted to the stationary armrest frame.

In some embodiments, the movable seat pan frame is horizontally translatable, and the movable armrest frame is vertically translatable.

In some embodiments, the seat pan subassembly and the armrest subassembly are decoupled such that, in use to transition the assembly to the temporary transfer position, the movable armrest frame is translated first and the movable seat pan frame is translated second such that the movable seat pan frame moves over a top of the armrest subassembly.

In some embodiments, the stationary armrest frame is coupled to the movable seat pan frame such that the stationary armrest frame travels with the movable seat pan frame between the first position and the second position of the movable seat pan frame, and wherein the movement of the movable seat pan frame is independent of the movement of the movable armrest frame.

In some embodiments, the movable seat pan frame is rotatably mounted to the stationary seat pan frame, the stationary armrest frame is mounted to the movable seat pan frame, and the movable armrest frame is translatably mounted to the stationary armrest frame.

In some embodiments, the movable seat pan frame is pivotably mounted atop the stationary seat pan frame.

According to another aspect, the inventive concepts according to the present disclosure are directed to an aircraft passenger seat configured to transition between a sitting position and a temporary transfer position. In embodiments, the aircraft passenger seat includes a seat back subassembly, a first armrest subassembly, a seat pan subassembly according to the above, and a second armrest subassembly according to the above, wherein the seat back subassembly and the first armrest subassembly are dissociated with the transition between the sitting position and the temporary transfer position.

According to a further aspect, the inventive concepts according to the present disclosure are directed to a seating layout for an aircraft passenger cabin. In embodiments, the seating layout includes a longitudinal aisle, and a passenger seat positioned laterally adjacent to the longitudinal aisle, the passenger seat configured to transition between a sitting position and a temporary transfer position according to the above, and wherein, when the passenger seat is in the sitting position the movable seat pan frame and the movable armrest frame are positioned out of the longitudinal aisle, and when the passenger seat is in the temporary transfer position the movable seat pan frame and the movable armrest frame are positioned at least partly in the longitudinal aisle.

This summary is provided solely as an introduction to subject matter that is fully described in the following detailed description and drawing figures. This summary should not be considered to describe essential features nor be used to determine the scope of the claims. Moreover, it is to be understood that both the foregoing summary and the following detailed description are explanatory only and are not necessarily restrictive of the subject matter claimed.

### BRIEF DESCRIPTION OF THE DRAWINGS

Implementations of the inventive concepts disclosed herein may be better understood when consideration is given to the following detailed description thereof. Such description refers to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 is a top plan view of a seating layout for a passenger cabin such as an aircraft passenger cabin, in accordance with example embodiments of this disclosure;

FIG. 2 is an isometric view of a first passenger seat assembly shown in a temporary transfer position, in accordance with example embodiments of this disclosure;

FIG. 3 is an isometric view of seat pan and armrest subassemblies of the first passenger seat assembly shown in their respective configurations corresponding to the sitting position, in accordance with example embodiments of this disclosure;

FIG. 4 is an isometric view of the seat pan and armrest subassemblies of the first passenger seat assembly shown in their respective configurations corresponding to the temporary transfer position, in accordance with example embodiments of this disclosure;

FIG. 5 is a side elevation view of seat pan and armrest subassemblies of the first passenger seat assembly shown in their respective configurations corresponding to the temporary transfer position, in accordance with example embodiments of this disclosure;

FIG. 6 is an isometric view of the seat pan and armrest subassemblies of the first passenger seat assembly showing the respective motion mechanisms, in accordance with example embodiments of this disclosure;

FIG. 7 is an isometric view of a second passenger seat assembly shown in a temporary transfer position, in accordance with example embodiments of this disclosure;

FIG. 8 is an isometric view of seat pan and armrest subassemblies of the second passenger seat assembly shown in their respective configurations corresponding to the sitting position, in accordance with example embodiments of this disclosure;

FIG. 9 is an isometric view of the seat pan and armrest subassemblies of the second passenger seat assembly showing the movable seat pan frame in the second position and the movable armrest frame in the first position, in accordance with example embodiments of this disclosure;

FIG. 10 is an isometric view of the seat pan and armrest subassemblies of the second passenger seat assembly shown in their respective configurations corresponding to the temporary transfer position, in accordance with example embodiments of this disclosure;

FIG. 11 is an isometric view of a third passenger seat assembly shown in a temporary transfer position, in accordance with example embodiments of this disclosure;

FIG. 12 is an isometric view of seat pan and armrest subassemblies of the third passenger seat assembly showing the movable seat pan frame in the second position and the movable armrest frame in the first position, in accordance with example embodiments of this disclosure; and

FIG. 13 is an isometric view of the seat pan and armrest subassemblies of the third passenger seat assembly shown in their respective configurations corresponding to the temporary transfer position.

### DETAILED DESCRIPTION

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein, a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination of sub-combination of two or more such features, along with any other features which may not necessarily be expressly described or inherently present in the instant disclosure.

Broadly, the present disclosure is directed to provisions for facilitating seat access for reduced mobility passengers in an aircraft or other conveyance. In embodiments, the present disclosure provides subassemblies for mounting onto passenger seat assemblies, wherein the subassemblies include components movable between a standard sitting position and a temporary transfer position. In some embodiments, two different subassemblies are provided wherein the movements are coordinated to achieve the temporary transfer position.

In embodiments in which a passenger seat is positioned adjacent to an aisle, the subassemblies function to move the movable components closer to or at least partly into the aisle to, for example, be positioned nearer to a transfer wheelchair. In some embodiments, the subassemblies when in their respective sitting positions have the appearance of a standard access seat, and thus serve to achieve a cohesive look throughout the cabin. In addition, the subassemblies obviate the need for spatial expansion around a seat to facilitate access. The cabin may include one or more passenger seats equipped with the subassemblies according to the present disclosure. In a particular conceived example, the cabin may be equipped with several passenger seats including the subassemblies, wherein the seats are spaced apart throughout the cabin and positioned adjacent to an aisle or other open space for temporarily receiving the movable components.

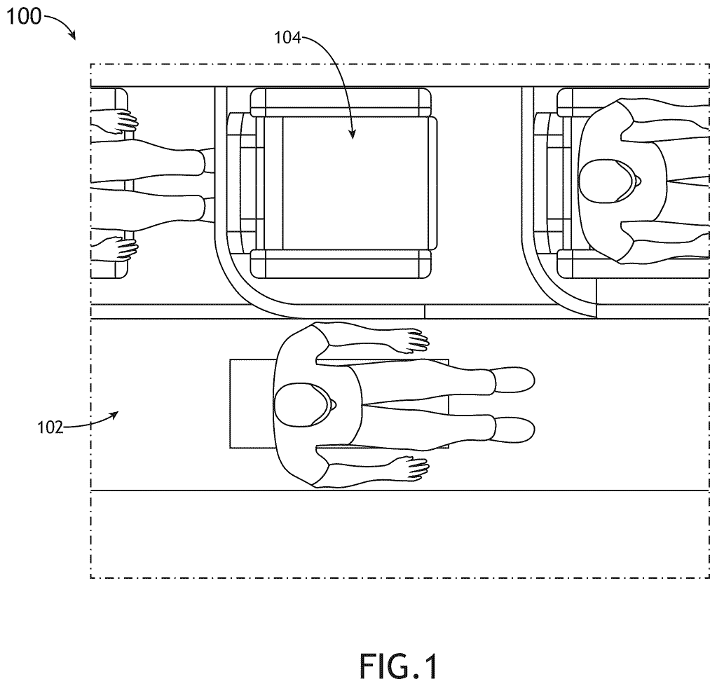

FIG. 1 illustrates a non-limiting example of a portion of a passenger cabin 100 including a longitudinal aisle 102 positioned next to a column of passenger seats 104. While the seats 104 shown are configured as individual seats, other configurations may include two seat units and seat rows including three or more seats. In the case of a seat unit or seat row, the seat(s) adjacent to the aisle 102 may be equipped with the subassemblies described herein wherein the seat(s) apart from the aisle may be standard access seats. For example, in a widebody airliner including port, starboard, and center seat columns separated by longitudinal aisles, any one or more seats positioned directly adjacent to an aisle may be equipped with the subassemblies described herein. While forward facing seats 104 are shown, other orientations may include seats angled toward or away from an aisle or other space capable of temporarily accommodating the movable seat components.

As described herein, the subassemblies work in conjunction to transition the passenger seat 104 between a sitting position as shown in FIG. 1, and various temporary transfer positions as described below. In embodiments, when the subassemblies are in a first position the passenger seat is in a TTOL compliant sitting position, and when the subassemblies are in a second position the passenger seat is in a temporary transfer position that may not be TTOL compliant. The temporary transfer position may be used during boarding and deplaning, for example, when the aircraft is parked at the gate. In use, the flight crew may adjust the passenger seat to the temporary transfer position during the boarding phase for PRM passengers, and once the transfer is complete, adjust the passenger seat back to the sitting position for TTOL and flight.

The passenger seat 104 according to the present disclosure is an assembly generally including a seat frame, a seat back subassembly, a first armrest subassembly, a seat pan subassembly, and a second armrest subassembly. The passenger seat 104 may further include a leg rest subassembly. Motions of the various subassemblies may be controlled and coordinated by traditional actuators, linkages, and a seat controller to adjust the seat between the upright sitting position and various reclined sitting positions. For example, movements of certain seat components may drive movements of other seat components. Component movements may be independent or coordinated. In some embodiments, the first armrest subassembly corresponds to an inboard armrest position (i.e., apart from an aisle) and therefore may have a different configuration and functionality as compared to the second armrest subassembly configured to achieve the temporary transfer position. In some embodiments, the first and second armrest subassemblies may be the same to provide vertical armrest adjustment. The seat pan and armrest subassemblies provided herein are compatible with other seat systems including, but not limited to, translation assemblies and swivel assemblies.

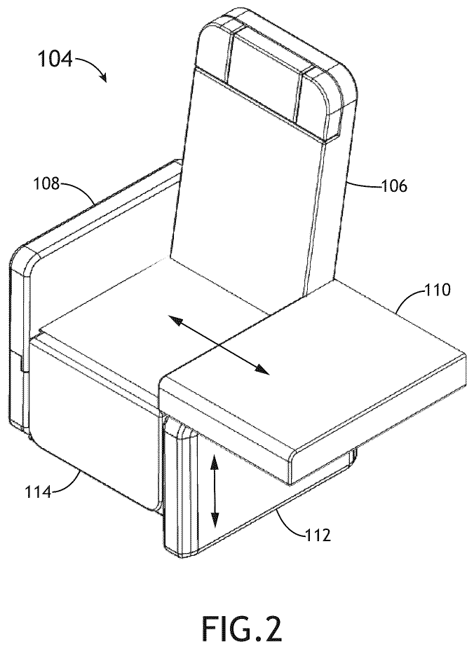

FIGS. 2-6 illustrate the passenger seat 104 according to the first embodiment of the present disclosure. The passenger seat 104 generally include a seat frame supporting a seat back subassembly 106, a first armrest subassembly 108, a seat pan subassembly 110, a second armrest subassembly 112, and an optional leg rest subassembly 114. The seat pan subassembly 110 and the second armrest subassembly 112 are separately mounted such that, to achieve the temporary transfer position, a portion of the second armrest subassembly 112 lowers first and a portion of the seat pan subassembly 110 moves laterally second. In use, a portion of the second armrest subassembly 112 lowers first to clear the seat pan such that part of the seat pan subassembly 110 can move laterally outward over the top of the lowered second armrest subassembly 112. The temporary transfer position can be used, for example, to position the seat pan in or closer to the aisle and away from the armrest to facilitate seat transfer.

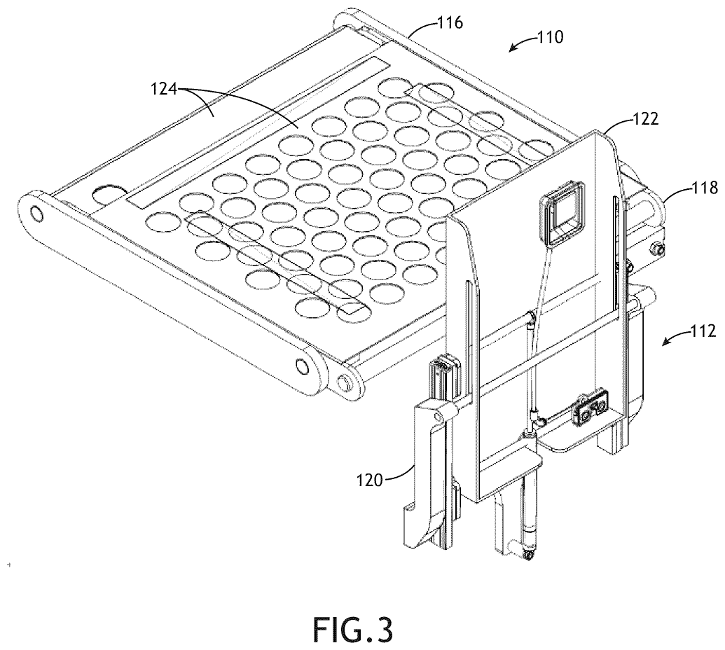

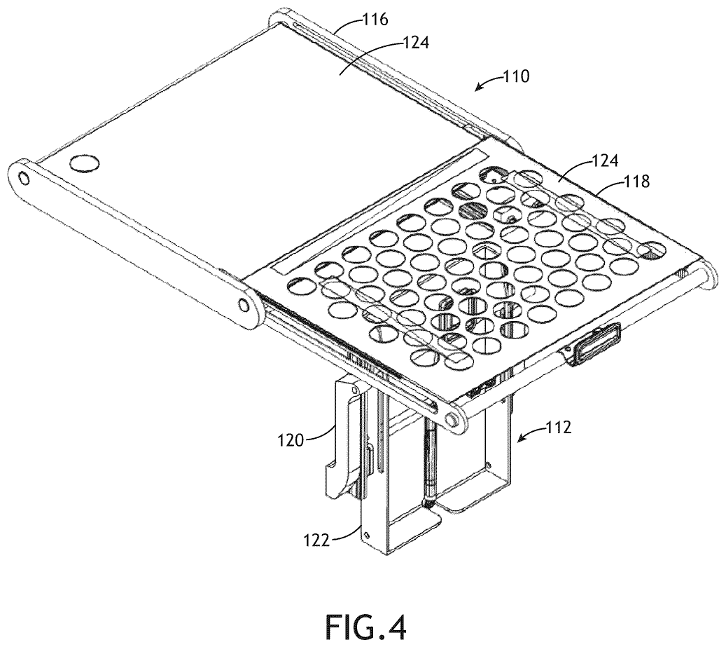

FIGS. 3 and 4 illustrate subassembly components. The seat pan subassembly 110 includes a stationary seat pan frame 116, and a movable seat pan frame 118 mounted to the stationary seat pan frame 116. In use, the movable seat pan frame 118 is movable substantially horizontally between a first position corresponding to the sitting position shown in FIG. 3, and a second position corresponding to the temporary transfer position shown in FIG. 4. The armrest subassembly 112 includes a stationary armrest frame 120, and a movable armrest frame 122 mounted to the stationary armrest frame 120. In use, the movable armrest frame 122 is movable substantially vertically between a first position corresponding to the sitting position shown in FIG. 3, and a second position corresponding to the temporary transfer position shown in FIG. 4. As installed in an aircraft, the armrest subassembly 112 would be positioned adjacent to open space, for instance alongside an aisle, such that the movable seat pan frame 118 is movable toward the aisle and over the top of the lowered movable armrest frame 122. The term ‘stationary’ as used herein does not necessarily mean fixed, but is use relatively in reference to the respective movable frame.

Each of the stationary seat pan frame 116 and the movable seat pan frame 118 generally includes parallel spaced and attached frame elements. The interface between the frames 116, 118 may include an elongated slot, toothed rail, or other traditional mechanism for translating the movable seat pan frame 122 back and forth between the first and second positions. Each of the frames 116, 118 may further include a top cover 124, wherein the top cover of the movable seat pan frame 118 is used to seat and secure a cushion as shown in FIG. 2, and the top cover of the stationary seat pan frame 116 ensures the opening into the seat is closed when the movable seat pan frame 118 is in the second position.

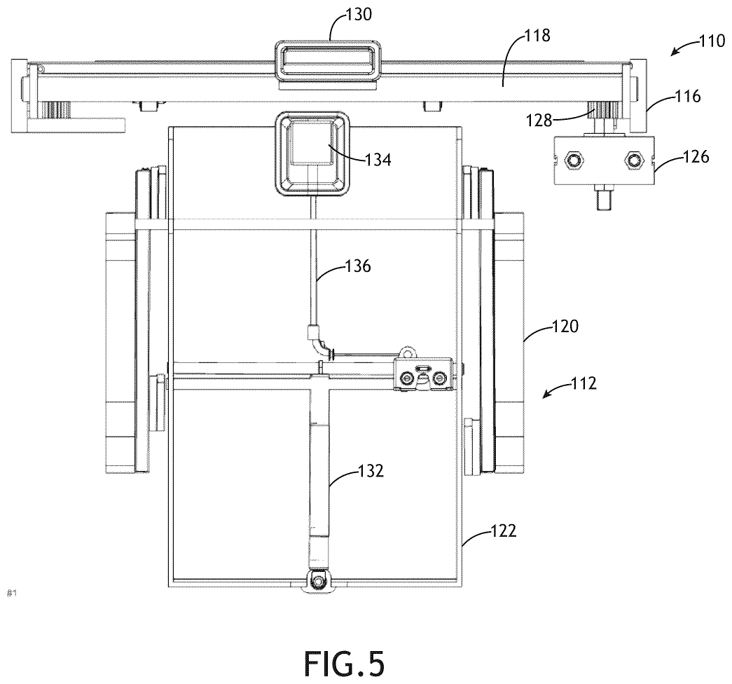

FIG. 5 illustrates the positional relationship between the seat pan subassembly 110 and the second armrest subassembly 112, and more specifically, the clearance provided by the lowered movable armrest frame 122 that allows the movable seat pan frame 118 to move over the top of the second armrest subassembly 112. In embodiments, motion of the movable seat pan frame 118 may be controlled by an actuator 126 coupled between the stationary seat pan frame 116 and the movable seat pan frame 118. In use, the actuator 126, which may interface with the movable seat pan frame 118 through a rotating toothed gear 128, may be electrically coupled to a seat controller or to a dedicated control 130 mounted to the seat pan subassembly 110.

In embodiments, the motion of the movable armrest frame 122 may be controlled by a locking gas spring 132 coupled between the stationary armrest frame 120 and the movable armrest frame 122. In use, lowering the movable armrest frame 122 stored potential energy in the locking gas spring 132 used to provide lift assistance for returning the movable armrest frame 122 to the first position (i.e., raised position). In embodiments, a release handle 134 may be mounted on the outboard facing side of the movable armrest frame 122 which is coupled to the locking gas spring 132 through a translating cable 136, for instance a Bowden cable configuration.

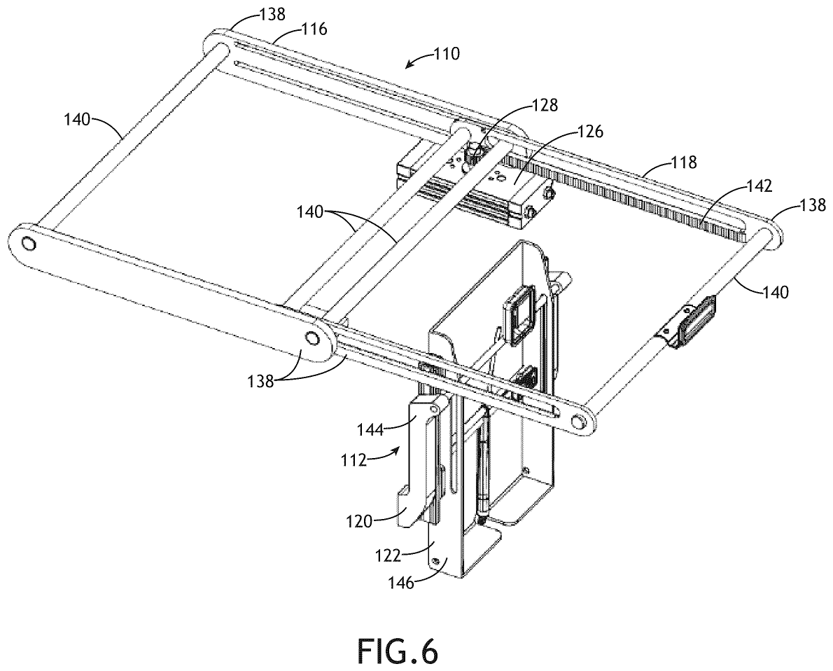

FIG. 6 illustrates further details of the seat pan subassembly 110 and the armrest subassembly 112. In embodiments, each of the stationary seat pan frame 116 and the movable seat pan frame 118 includes forward and aft parallel frame members 138 and left and right parallel transverse frame members 140. A horizontal toother rail 142 may be mounted to an inboard side of one of the forward and aft frame members 138 of the movable seat pan frame 116. The toothed rail 142 is meshed with the rotating toothed gear 128 of the actuator 126 configured to drive the horizontal translation of the movable seat pan frame 118. As further shown, the movable seat pan frame 118 tracks inboard of the stationary seat pan frame 116 and the two frames interface through an elongated slot arrangement.

In embodiments, the stationary armrest frame 120 includes vertical guideposts 144 mountable to the seat frame, and the movable armrest frame 122 includes a housing 146 translatably mounted between the guideposts 144. The interface therebetween may also be a guide and guideway arrangement of another traditional mechanism for controlling translating motion. Additional armrest components not shown may include an armrest cap and an armrest pad, among other components.

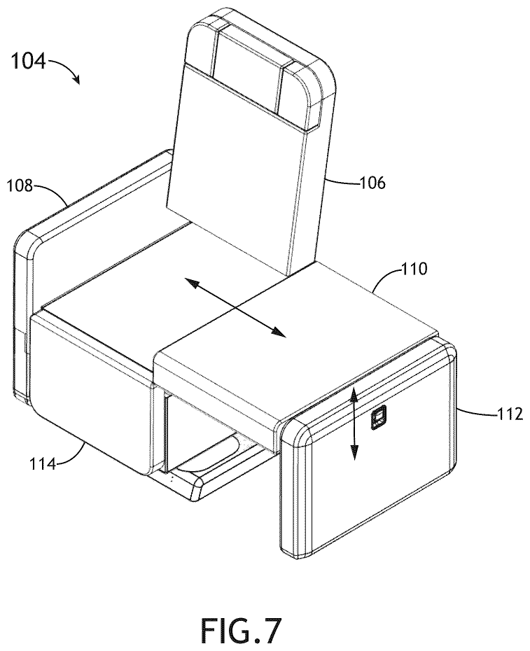

FIGS. 7-10 illustrate the passenger seat 104 according to the second embodiment of the present disclosure. The passenger seat 104 also generally includes a seat frame supporting a seat back subassembly 106, a first armrest subassembly 108, a seat pan subassembly 110, a second armrest subassembly 112, and an optional leg rest subassembly 114. Whereas in the first embodiment the seat pan subassembly 110 and the second armrest subassembly 112 are separately or independently mounted, in the second embodiment the second armrest assembly is mounted to the movable seat pan frame such that the entire second armrest subassembly moves laterally with the lateral motion of the seat pan assembly. This configuration obviates the need for a specific sequence of motions considering the position of the two movable frame members do not interfere.

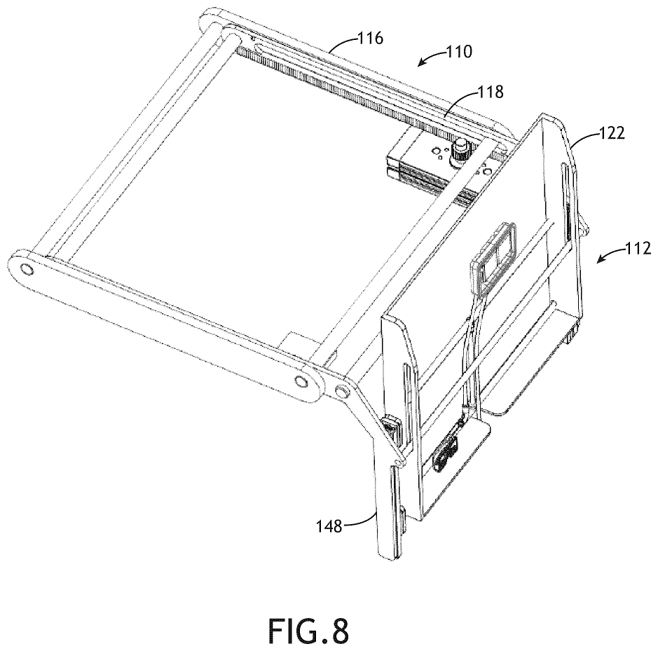

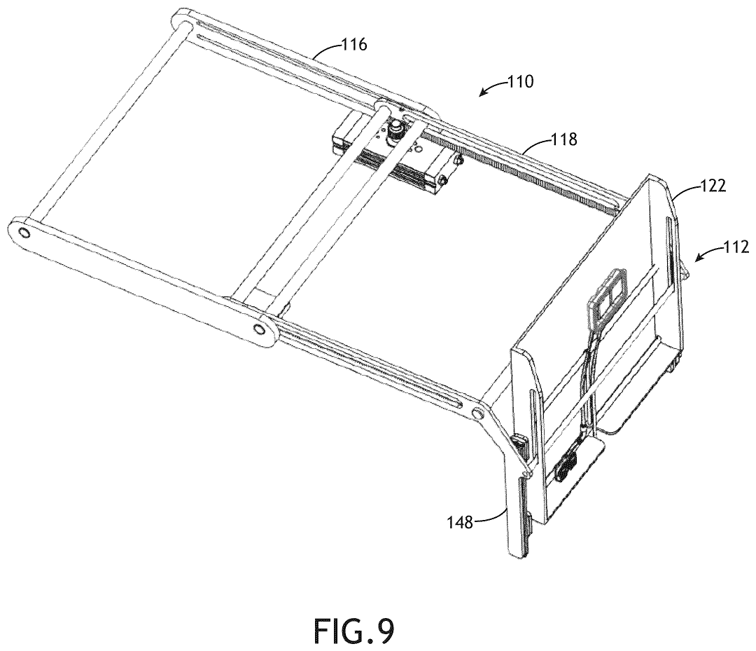

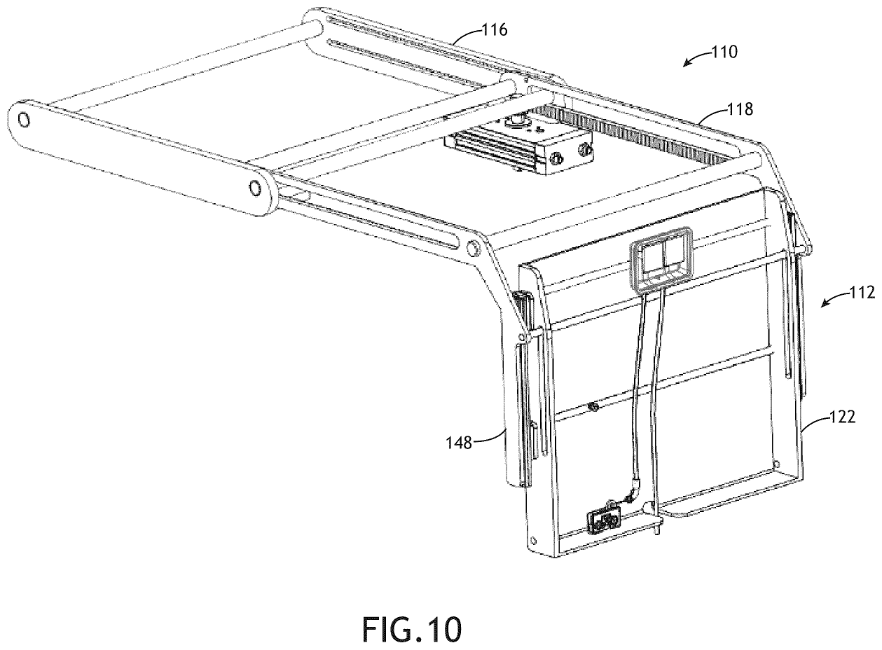

FIGS. 8-10 illustrate the subassembly components. FIG. 8 shows the movable seat pan frame 118 in the first position and the movable armrest frame 122 in the first position, wherein the first positions correspond to the sitting position. FIG. 9 shows the movable seat pan frame 118 translated to the second position and the movable armrest frame 122 still in the first position. FIG. 10 shows the movable seat pan frame 118 in the second position and the movable armrest frame 122 in the second position, wherein the second position corresponds to the temporary transfer position. The configurations shown in FIGS. 9 and 10 may both correspond to the temporary transfer position depending on whether the movable armrest frame 122 interferes with or helps facilitate transfer.

The subassembly components are essentially the same as in the first embodiment with the differences being the particular configuration of the movable seat pan frame 118 that allows for attachment to the movable armrest frame 122. As shown, the vertical extensions 148 of the movable seat pan frame 118 essentially replace the guideposts of the stationary armrest frame such that the movable armrest frame 122 is translatably mounted between the vertical extensions 148.

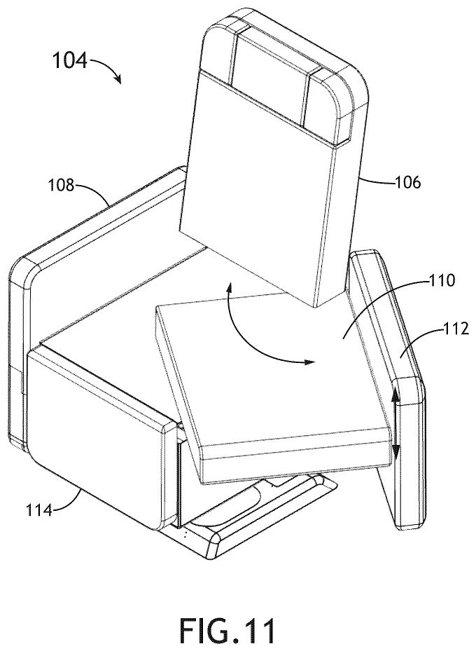

FIGS. 11-13 illustrate the passenger seat 104 according to the third embodiment of the present disclosure. The passenger seat 104 also generally includes a seat frame supporting a seat back subassembly 106, a first armrest subassembly 108, a seat pan subassembly 110, a second armrest subassembly 112, and an optional leg rest subassembly 114. Whereas in the first and second embodiments the seat pan subassembly 110 includes a translating seat pan frame component, in the third embodiment the movable seat pan frame component is rotatably mounted. Consistent with the second embodiment, the second armrest subassembly 112 is also mounted to the movable seat pan frame. Thus, this configuration also obviates the need for a specific sequence of motions considering the position of the two movable frame members do not interfere.

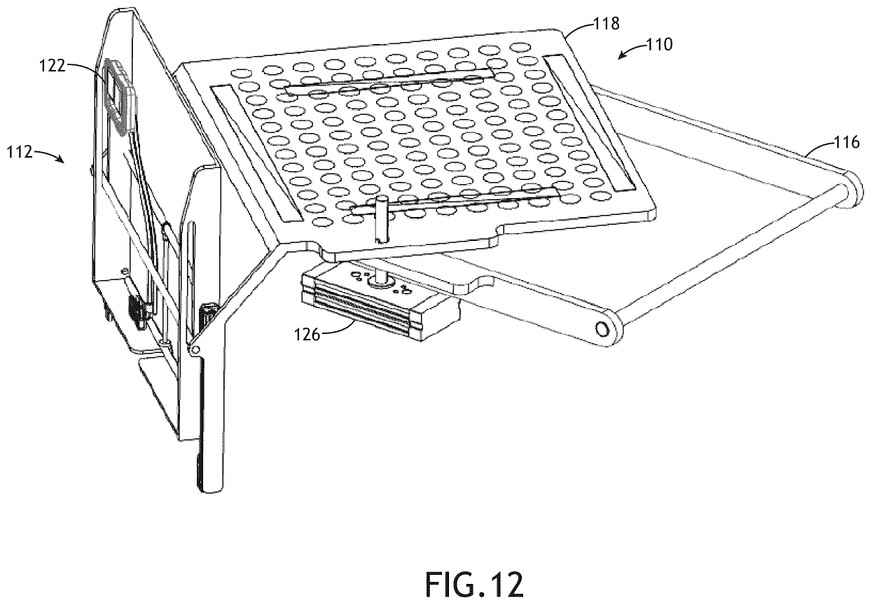

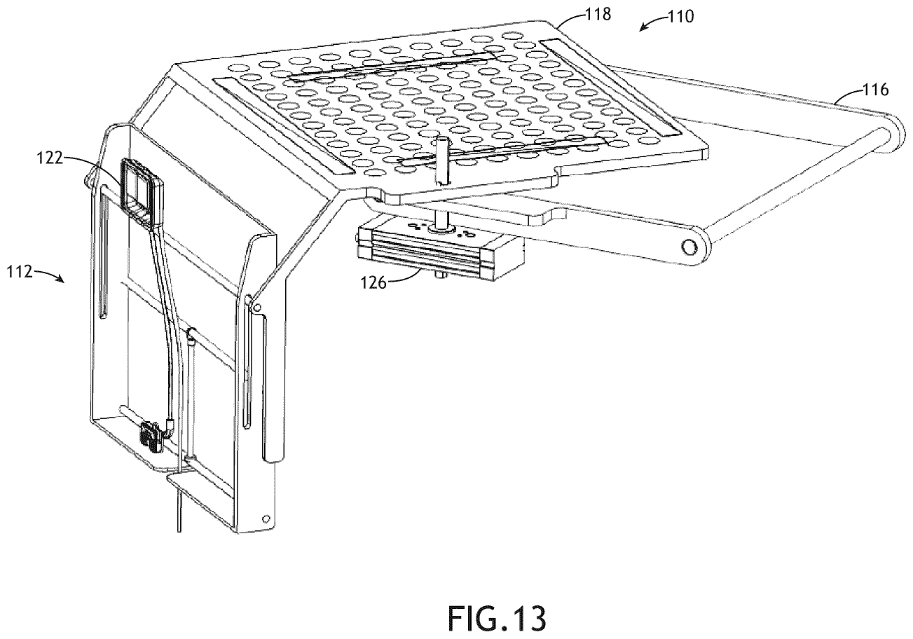

FIGS. 12 and 13 illustrate the subassembly components. FIG. 12 shows the movable seat pan frame 118 rotatably coupled to the stationary seat pan frame 116 through the same rotating actuator 126, the difference being that the rotating actuator is directly coupled to the movable seat pan frame 118 such that the movable seat pan frame 118 rotates with the actuator. FIG. 12 shows the movable seat pan frame 118 in the second position and the movable armrest frame 122 in the first position, whereas FIG. 13 shows both movable frames 118, 122 in their respective second position to achieve the temporary transfer position. The subassembly components are essentially the same as described above with the difference being the particular configuration and attachment of the rotating seat pan frame 118.

From the above description, it is clear that the inventive concepts disclosed herein are well adapted to achieve the objectives and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. An assembly configured to be mounted to a passenger seat, the assembly configured to transition between a sitting position and a temporary transfer position, and the assembly comprising:
a seat pan subassembly including:
a stationary seat pan frame; and
a movable seat pan frame mounted to the stationary seat pan frame, the movable seat pan frame movable between a first position corresponding to the sitting position and a second position corresponding to the temporary transfer position; and
an armrest subassembly including:
a stationary armrest frame; and
a movable armrest frame mounted to the stationary armrest frame, the movable armrest frame movable between a first position corresponding to the sitting position and a second position corresponding to the temporary transfer position.

2. The assembly according to claim 1, further comprising:
an actuator coupled between the stationary seat pan frame and the movable seat pan frame configured to move the movable seat pan frame between the first position and the second position; and
a locking gas spring coupled between the stationary armrest frame and the movable armrest frame, the locking gas spring configured to store energy when the movable armrest frame is moved toward the second position and provide lift assistance to move the movable armrest frame toward the first position.

3. The assembly according to claim 1, wherein:
the movable seat pan frame is translatably mounted to the stationary seat pan frame; and
the movable armrest frame is translatably mounted to the stationary armrest frame.

4. The assembly according to claim 3, wherein:
the movable seat pan frame is horizontally translatable; and
the movable armrest frame is vertically translatable.

5. The assembly according to claim 4, wherein the seat pan subassembly and the armrest subassembly are decoupled such that, in use to transition the assembly to the temporary transfer position, the movable armrest frame is translated first and the movable seat pan frame is translated second such that the movable seat pan frame moves over a top of the armrest subassembly.

6. The assembly according to claim 4, wherein the stationary armrest frame is coupled to the movable seat pan frame such that the stationary armrest frame travels with the movable seat pan frame between the first position and the second position of the movable seat pan frame, and wherein the movement of the movable seat pan frame is independent of the movement of the movable armrest frame.

7. The assembly according to claim 1, wherein:
the movable seat pan frame is rotatably mounted to the stationary seat pan frame;
the stationary armrest frame is mounted to the movable seat pan frame; and
the movable armrest frame is translatably mounted to the stationary armrest frame.

8. The assembly according to claim 7, wherein the movable seat pan frame is pivotably mounted atop the stationary seat pan frame.

9. An aircraft passenger seat configured to transition between a sitting position and a temporary transfer position, the aircraft passenger seat comprising:
a seat back subassembly;
a first armrest subassembly;
a seat pan subassembly including:
a stationary seat pan frame; and
a movable seat pan frame mounted to the stationary seat pan frame, the movable seat pan frame movable between a first position corresponding to the sitting position and a second position corresponding to the temporary transfer position; and
a second armrest subassembly including:
a stationary armrest frame; and
a movable armrest frame mounted to the stationary armrest frame, the movable armrest frame movable between a first position corresponding to the sitting position and a second position corresponding to the temporary transfer position.

10. The aircraft passenger seat according to claim 9, wherein the seat back subassembly and the first armrest subassembly are dissociated with the transition between the sitting position and the temporary transfer position.

11. The aircraft passenger seat according to claim 9, further comprising:
an actuator coupled between the stationary seat pan frame and the movable seat pan frame configured to move the movable seat pan frame between the first position and the second position; and
a locking gas spring coupled between the stationary armrest frame and the movable armrest frame, the locking gas spring configured to store energy when the movable armrest frame is moved toward the second position and provide lift assistance to move the movable armrest frame toward the first position.

12. The aircraft passenger seat according to claim 9, wherein:
the movable seat pan frame is translatably mounted to the stationary seat pan frame; and
the movable armrest frame is translatably mounted to the stationary armrest frame.

13. The aircraft passenger seat according to claim 12, wherein:
the movable seat pan frame is horizontally translatable; and
the movable armrest frame is vertically translatable.

14. The aircraft passenger seat according to claim 13, wherein the seat pan subassembly and the armrest subassembly are decoupled such that, in use to transition the aircraft passenger seat to the temporary transfer position, the movable armrest frame is translated first and the movable seat pan frame is translated second such that the movable seat pan frame moves over a top of the armrest subassembly.

15. The aircraft passenger seat according to claim 13, wherein the stationary armrest frame is coupled to the movable seat pan frame such that the stationary armrest frame travels with the movable seat pan frame between the first position and the second position of the movable seat pan frame, and wherein the movement of the movable seat pan frame is independent of the movement of the movable armrest frame.

16. The aircraft passenger seat according to claim 9, wherein:
the movable seat pan frame is rotatably mounted to the stationary seat pan frame;
the stationary armrest frame is mounted to the movable seat pan frame; and
the movable armrest frame is translatably mounted to the stationary armrest frame.

17. The aircraft passenger seat according to claim 16, wherein the movable seat pan frame is pivotably mounted atop the stationary seat pan frame.

18. A seating layout for an aircraft passenger cabin, comprising:
a longitudinal aisle; and
a passenger seat positioned laterally adjacent to the longitudinal aisle, the passenger seat configured to transition between a sitting position and a temporary transfer position, and the passenger seat comprising:
a seat back subassembly;
a first armrest subassembly positioned apart from the longitudinal aisle;
a seat pan subassembly including:
a stationary seat pan frame; and
a movable seat pan frame mounted to the stationary seat pan frame, the movable seat pan frame movable between a first position corresponding to the sitting position and a second position corresponding to the temporary transfer position; and
a second armrest subassembly including:
a stationary armrest frame; and
a movable armrest frame mounted to the stationary armrest frame, the movable armrest frame movable between a first position corresponding to the sitting position and a second position corresponding to the temporary transfer position.
wherein:
when the passenger seat is in the sitting position, the movable seat pan frame and the movable armrest frame are positioned out of the longitudinal aisle; and
when the passenger seat is in the temporary transfer position, the movable seat pan frame and the movable armrest frame are positioned at least partly in the longitudinal aisle.

19. The seating layout according to claim 18, wherein the seat back subassembly and the first armrest subassembly are dissociated with the transition between the sitting position and the temporary transfer position.

20. The seating layout according to claim 18, wherein:
the movable seat pan frame is translatably or rotatably mounted to the stationary seat pan frame; and
the movable armrest frame is translatably mounted to the stationary armrest frame.
